(19) United States
(12) Patent Application Publication
(10) Pub. No.: US 2007/0177597 A1
(43) Pub. Date: Aug. 2, 2007

(54) Ethernet connection-based forwarding process

(76) Inventor: Yu Ju, Herndon, VA (US)

Correspondence Address: LITMAN LAW OFFICES, LTD., P.O. BOX 15035, CRYSTAL CITY STATION, ARLINGTON, VA, 22215, US

(21) Appl. No.: 11/345,394

(22) Filed: Feb. 2, 2006

(51) Int. Cl. H04L 12/56

(52) U.S. Cl. 370/392; 370/400

(57) ABSTRACT

The Ethernet connection-based forwarding process is a system and method of establishing a pre-determined transmission path before communicating frames of data over an Ethernet connection. The present invention supports reserving resources on each of the Ethernet switches which may be on a desired communications path while setting up the connection based forwarding tables. The present invention can differentiate two connections having the same destination MAC address but different source MAC addresses so that streams of frame data from the different sources can be merged and separated en-route to the destination, thus making it possible to reserve proper resources on the switches for a connection thereby satisfying QoS requirements for the connection. A provisioned connection also eliminates the requirement of a loop free active topology. The present invention also eliminates the requirement of spanning tree protocols so that all bridge ports may be accessed for forwarding of Ethernet frame data.

### BACKGROUND OF THE INVENTION

1. Field of the Invention

The present invention relates to connection based forwarding of Ethernet data frames.

2. Description of the Related Art

Ethernet is a network technology defined by the LAN/MAN Standards Committee of the IEEE Computer Society. It is specified in a family of IEEE 802 Standards. “IEEE Std 802—Overview and Architecture” provides an overview to the family of IEEE 802 Standards. An Ethernet network comprises Ethernet switches interconnected by links. Conventional Ethernet provides a connectionless technology. From the perspective of the Open Standards Interconnect (OSI) hierarchy of data communications, the Ethernet switches, bridges, and the like, operate in the domain of OSI layer 2.

As is well known in the art, conventional Ethernet networks use spanning tree protocols to increase network traffic efficiencies by detecting physical loops and logically disabling connections, i.e., blocking some of the bridge ports to break up the loops so that from any switch to switch topology, there is only one physical path enabled between the two switches. The loop free network is called an active topology. An active topology enforcement operation ensures that Ethernet frames are only accepted from and transmitted to ports in a forwarding state.

In an active topology for a VLAN on top of a physical Ethernet network, corresponding bridge ports frequently are blocked and thus not used to receive and forward Ethernet frames associated with such an active topology instance. The result is that under conventional Ethernet network topology, network resources (i.e. bridge ports) are not used efficiently.

In particular, a conventional Ethernet forwarding process receives an Ethernet frame with a VLAN tag and associates an active topology instance along with a filtering database instance to the frame based on the VLAN tag. The conventional process then applies the active topology enforcement on the incoming port using the associated active topology enforcement. Subsequently an output port is selected based on the destination address of the Ethernet frame in the associated filtering database instance. The active topology enforcement is applied on the selected output port using the associated active topology enforcement. Then the Ethernet frame is forwarded on the selected output port.

When the aforementioned conventional Ethernet forwarding process looks up a filtering database it uses only a destination MAC address to determine an outgoing bridge port.

The aforementioned look up process makes network resource allocation along the forwarding path to guarantee the QoS requirements demanded by traffic flow infeasible because knowledge of a destination MAC address alone does not provide sufficient information to uniquely identify a traffic flow within the Ethernet network. Additionally, there is usually much data traffic having the same destination MAC address but different source MAC addresses. Moreover, lookup results usually change when active topology changes, thus making the forwarding path for Ethernet frames unpredictable. Therefore, conventional Ethernet networks do not provide end-to-end QoS.

Virtual Bridged LANs (VLANs) as described in the Institute of Electrical and Electronics Engineers (IEEE) standard 802.1Q, standardized the development of a mechanism to allow multiple bridged networks to transparently share the same physical network link without leakage of information between the networks. Hardware developed to facilitate the standard includes VLAN-aware Ethernet switches which use VLAN IDs (VIDs), i.e., VLAN tags, to associate an active forwarding topology and a forwarding database instance to a received Ethernet frame. A VLAN- aware Ethernet switch then forwards the Ethernet frame, following the constraints of the associated active topology and according to the filtering database that is based on the destination MAC address.

Additionally, a related art proposal exists to create a label switched path (LSP) within an Ethernet network and use VLAN ID as the switching label. However, label switching on VLAN ID requires re-calculation of a portion of a MAC frame known as the frame check sequence (FCS). Additional time, i.e., overhead, is needed to forward an Ethernet frame along the LSP. Thus, unlike the present invention, the aforementioned proposal fails to provide a connection based forwarding process having low processing overhead.

Japanese patent JP 7066816, dated March, 1995, appears to discuss filtering frame traffic received by a PC on a LAN by setting up a filtering device in a switch ahead of the PC, however, unlike the present invention, does not appear to discuss a methodology for separating frames having a same destination MAC address.

Japanese patent JP 7235949, dated September, 1995, appears to discuss changing an originating MAC address to a MAC address of a receiving bridge to eliminate a call originating address collation circuit but, unlike the present invention, does not apparently discuss a methodology for separating frames having a same destination MAC address.

Conventional Ethernet uses globally unique destination MAC addresses for forwarding. A proposal known in the art uses a 60-bit label to forward Ethernet frames. The 60-bit label is composed of a 12-bit VLAN tag and a 48-bit destination MAC address.

However, in the event that a destination address corresponding to a destination node of the connection and an identifier, such as a VLAN tag to establish a connection are used, there still exists the problem that these aforementioned methods, even with increased addressing power of the 60 bit label, cannot differentiate data frames with the same destination MAC address and VLAN tag, but having a different source MAC address.

Thus the aforementioned methods can not set up different connections for data frames having the same destination MAC address and VLAN tag but having a different source MAC address, i.e., unlike the present invention, the two connections passing through one common switch cannot be differentiated on that switch and must take the same path thereafter. It should be noted that QoS cannot be guaranteed for two such connections, since two merged connections starting from a common switch cannot be differentiated.

Thus, an Ethernet connection-based forwarding process solving the aforementioned problems is desired.

### SUMMARY OF THE INVENTION

The Ethernet connection-based forwarding process is a system and method of establishing a pre-determined transmission path based on an incoming port, source MAC address, and destination MAC address, before communicating frames of data over an Ethernet connection. The present invention reserves resources on each of the Ethernet switches which may be on a desired communications path, while setting up the connection based forwarding tables.

The present invention allows for provisioning connections across the Ethernet network, thus enabling streams of frame data having a same destination MAC address to be merged and separated en-route to the destination, so that an Ethernet carrier may satisfy a customer's QoS requirements. According to the connection based forwarding process of the present invention, an Ethernet carrier can put all bridge ports into a connection-based forwarding state, thus fully utilizing all of the network's physically available bridge ports.

A provisioned connection also eliminates the requirement of a loop free active topology. The present invention also eliminates the requirement of spanning tree protocols, thus allowing for all bridge ports to be accessed for forwarding of Ethernet frame data.

These and other features of the present invention will become readily apparent upon further review of the following specification and drawings.

### BRIEF DESCRIPTION OF THE DRAWINGS

FIG. 1 is a flow diagram of the Ethernet connection based forwarding process, according to the present invention.

FIG. 2 is an environmental, diagrammatic view of network elements using the Ethernet connection based forwarding process, according to the present invention.

FIG. 3 is a source-destination data flow pattern established by the Ethernet connection based forwarding process, according to the present invention.

FIG. 4 is a multicast source-destination data flow pattern established by the Ethernet connection based forwarding process, according to the present invention.

FIG. 5 depicts database table entry setup for two unidirectional unicast connections, according to the present invention.

FIG. 6 depicts database table entry setup for a unidirectional multicast connection, according to the present invention.

FIG. 7 is a diagrammatic component view of a tagged Ethernet frame.

Similar reference characters denote corresponding features consistently throughout the attached drawings.

### DETAILED DESCRIPTION OF THE PREFERRED EMBODIMENT

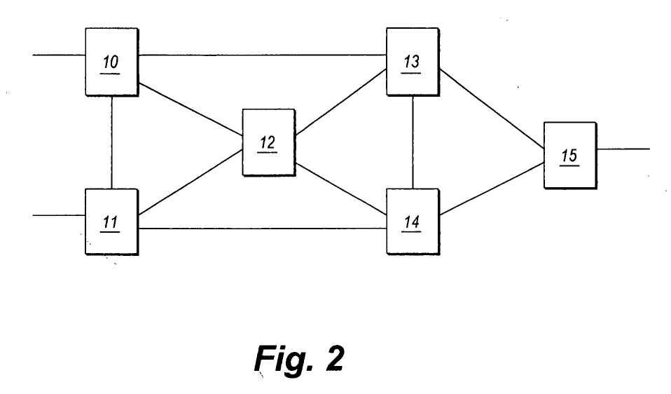

The present invention is a system and method of establishing a pre-determined transmission path by utilizing frame transmission filters based on an incoming port, a source MAC address, and a destination MAC address, before communicating frames of data over an Ethernet connection. FIG. 2 depicts a typical hardware mesh of switches, such as switches 10 through 15. The present invention has the capability to reserve resources on each of the Ethernet switches 10 through 15 which may be on a desired communications path, through setting up connection based forwarding tables functioning as filters in a database instance having mapping information related to an incoming port, a source MAC address, and a destination MAC address.

The Ethernet connection-based forwarding process of the present invention allows for provisioning connections across the Ethernet network so that an Ethernet carrier, i.e., service provider, may satisfy a customer's QoS requirements. A provisioned connection also eliminates the requirement of a loop free active topology. The present invention also eliminates the requirement of spanning tree protocols so that all bridge ports may be accessed for forwarding of Ethernet frame data.

The present invention allows for the capability of putting all bridge ports into a connection-based forwarding state that fully utilizes all physically available bridge ports within a network. Network utilization is complete across all of the bridge ports since no bridge port is blocked in the connection-based forwarding state, according to the present invention.

According to the present invention, a connection-based active topology instance comprises bridge ports in a connection-based forwarding state. Unlike conventional Ethernet networks, the connection-based active topology according to the present invention has the capability to efficiently operate in the presence of physical loops, thus obviating the necessity to perform selective port blocking.

The present invention provides for full utilization of all the physically available bridge ports for connection-based forwarding, thus enabling network operators to implement their network more efficiently. Additionally, the connection-based forwarding process as contemplated by the present invention eliminates the need for spanning tree protocols. Advantageously, the present invention provides for bridge ports in the connection-based forwarding state to have the capability to form any kind of meshed topology.

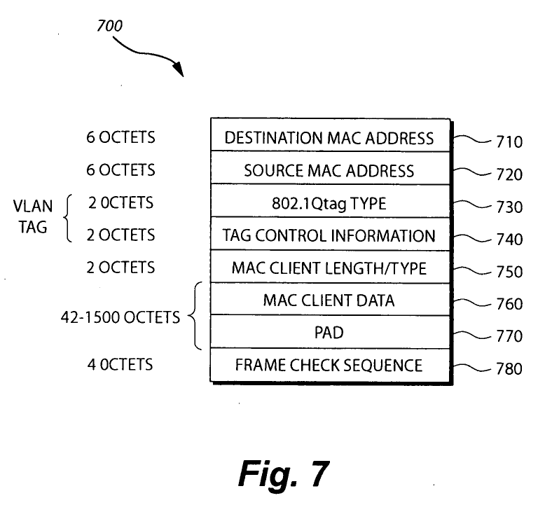

The Ethernet network operator can use any configuration means to put a bridge port into a connection-based forwarding state. A connection-based forwarding database instance, as provided by the present invention, is composed of mappings derived from a combination of the incoming interface, i.e., switch port, the destination MAC address 710, and the source MAC address 720, as shown in FIG. 7.

The mappings are applied to select output ports on that switch. A received Ethernet frame VLAN tag comprising an 802.1Qtag Type 730 and Tag Control Information 740 is used to associate a connection-based active topology instance and a connection-based forwarding database instance to the Ethernet frame 700.

If the incoming bridge port is in the connection-based forwarding state as indicated by the associated connection-based active topology instance, the associated connection-based forwarding database instance is looked up for a mapping with the combination of the incoming interface, i.e., switch port, the destination MAC address 710, and the source MAC address 720.

On the return of a successful lookup, the mapping is applied to select a set of output bridge ports on the switch. The Ethernet frame 700 is then forwarded out of the output bridge's ports which are also in a connection-based forwarding state as provided by the associated connection-based active topology instance.

A uni-directional connection is established in the Ethernet network by configuring in one or more Ethernet switches the association of a VLAN tag to a connection-based active topology instance, a connection-based forwarding database instance, and the mappings in the associated connection-based forwarding database instance. Thus, because the switches are VLAN-aware, the connection-based forwarding method can use the same network physical resources that also have a connectionless based forwarding method running on them.

According to the present invention, QoS requirements for a connection are satisfied by reserving enough network resources on the switches when the connection is provisioned. QoS requirements satisfaction is achievable since at the time when the connection is being provisioned, the switches on the connection path are known, and the incoming ports and outgoing ports on each of the switches on the connection path are known.

An Ethernet frame 700 is forwarded out unchanged since there is no requirement to change the VLAN tag, nor is there a requirement to re-compute FCS 780. Thus, the forwarding process according to the present invention is very fast, having less processing overhead than a conventional Ethernet network.

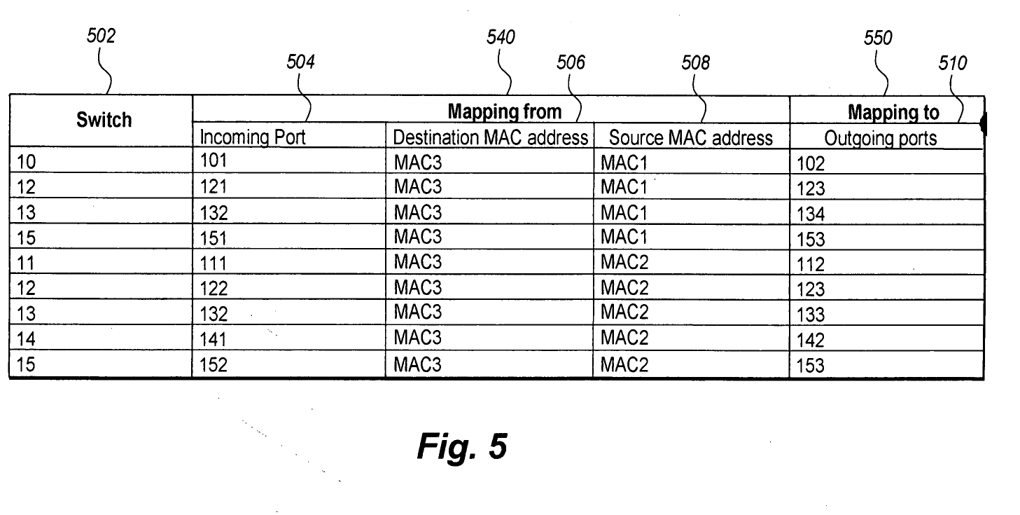

Each frame 700 received by a VLAN Bridge is classified as belonging to exactly one VLAN by associating a VLAN Identifier (VID) value derived from Qtag type 730 and Tag Control information 740 with the received frame 700. For each frame 700, based on the VID, the switch decides whether to apply the conventional Ethernet forwarding process or the connection-based forwarding process of the present invention. For example, the connection based forwarding process allocates a connection based filtering database instance to the VID. The connection based filtering database is identified by a connection-based filtering identifier (CFID). For a unicast Ethernet frame, the CFID is looked up based on the triple as shown in FIG. 5, i.e., incoming port located in table entry 504, destination MAC address 710 located in table entry 506, and source MAC address 720 of the received Ethernet frame, located in table entry 508. The result of the lookup is a bridge port for transmission.

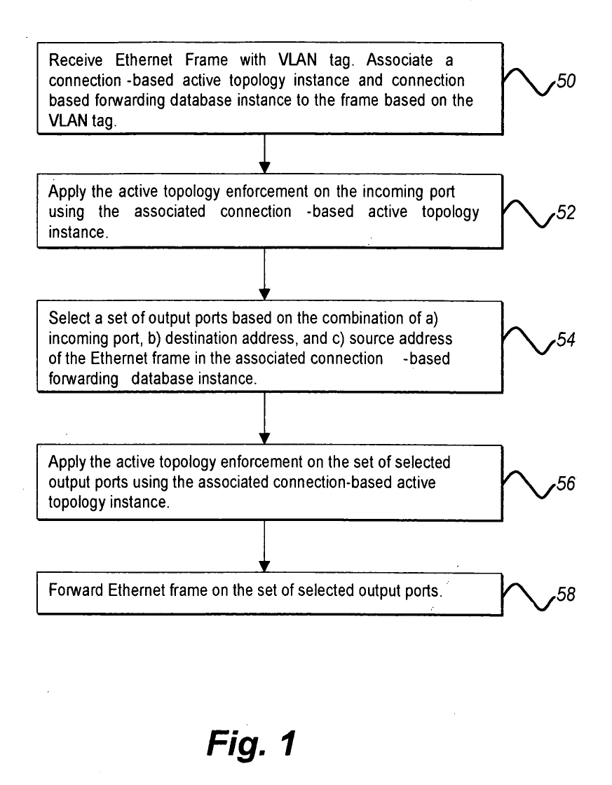

As shown in FIG. 1 at step 50, once a tagged Ethernet frame 700 is received at a VLAN-aware switch, the connection-based forwarding process associates a connection-based active topology instance and a connection-based forwarding database instance to the frame 700 based on the VID, i.e., VLAN tag. As shown in step 52, the connection-based active topology enforcement is applied on the incoming bridge port of the frame 700 using the associated connection-based active topology instance. If the incoming port is not in the connection-based forwarding state according to the associated connection-based active topology, the frame 700 is discarded, otherwise, processing on the frame 700 continues.

As shown at step 54, the connection-based forwarding process looks up the associated connection-based forwarding database for a mapping formed by the combination of the incoming bridge port, the destination MAC address 710, and the source MAC address 720 of the Ethernet frame 700 in the database instance. If no such mapping exists, the frame is discarded. A successful lookup results in a mapping that is applied to select a set of outgoing bridge ports on the switch.

As shown in FIG. 1 at step 56, the connection-based active topology enforcement checks the set of outgoing bridge ports against the associated connection-based active topology instance. For every bridge port in the set of outgoing bridge ports, if it is in the connection-based forwarding state according to the associated connection-based active topology, the frame 700 is forwarded out. According to step 58, the connection-based forwarding process forwards out the frame 700 without changing the VLAN tag or re-calculating FCS 780.

A bridge port may be set to a connection-based-forwarding state by user configuration or by other means. As long as a bridge port is in the connection-based-forwarding state, it may be used for receiving and forwarding Ethernet frames in the connection-based active topology.

FIG. 2 shows a connection-based active topology instance for VLAN 10. As shown, all the bridge ports are in a connection-based forwarding state. Thus they are all available for forwarding Ethernet frames. In contrast to the full utilization of bridge resources 10 through 15, as provided by the present invention, existing conventional loop free active topology must block some of the port connections, e.g., port connections between bridge 10 and bridge 11, bridge 10 and bridge 13, bridge 11 and bridge 14, bridge 13 and bridge 14, and finally, between bridge 14 and bridge 15.

The connection-based-forwarding state does not have any relationship with the pre-existing bridge port states as defined by spanning tree protocols. A bridge may still run spanning tree protocols, but the port states and active topology derived from the spanning tree protocols are not used in the connection-based forwarding process.

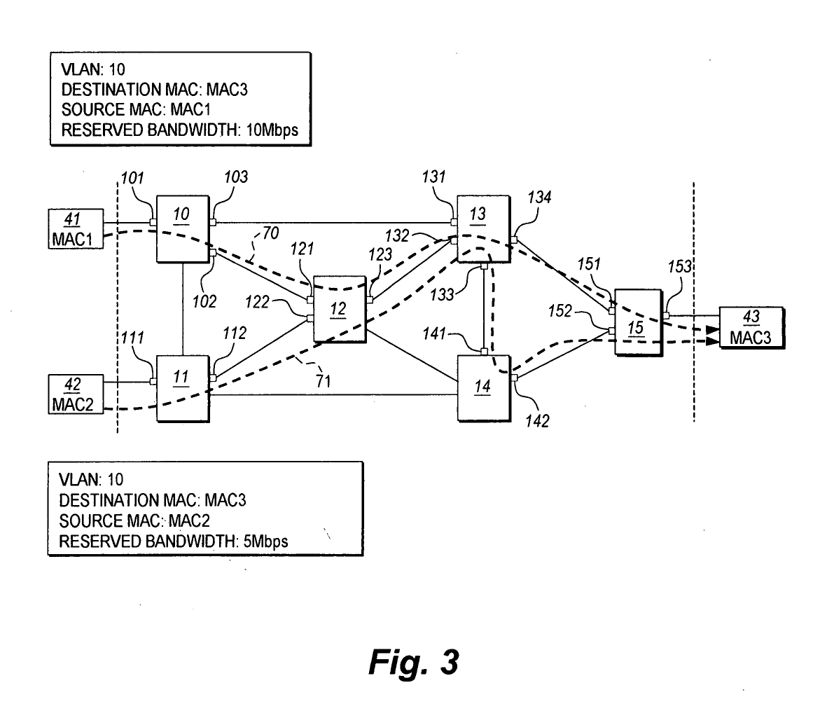

FIG. 5 shows the connection-based forwarding filtering databases associated to VLAN 10 connections shown in FIG. 3. The “switch” column shows which switch the mapping is applied to. The “mapping from” column shows the incoming port, the destination MAC address 710 and source MAC address 720 of the mapping. The “mapping to” column shows the outgoing ports of the mapping.

A uni-direction connection within an Ethernet network is provisioned by setting up proper connection-based forwarding database entries on the switches along the path of the connection. The path taken by the connection can be determined by any means, such as by network management software. The determined path identifies the switches the connection will pass through, as well as the order, in addition to identifying the incoming port and outgoing bridge ports. If the connection has some QoS requirements, proper network resources may be reserved on the switches in the signal path to satisfy the QoS requirement.

Since the path for the connection and the QoS requirement are pre-determined and known, the proper resource reservation along the path can be done.

FIG. 3 shows uni-directional unicast connection 70 and unidirectional unicast connection 71 associated with VLAN 10. These two connections are provisioned by setting up connection-based forwarding filtering databases, as illustrated in FIG. 5. Connection 70, associated with VLAN 10, has destination MAC address MAC3 at edge Ethernet switch 43, and source MAC address MAC1 at edge Ethernet switch 41. Connection 70 travels through switches 10, 12, 13, 15 in order, and reserves 10 Mbps bandwidth along the path.

Connection 71 also associated with VLAN 10, has destination MAC address MAC3 at edge Ethernet switch 43, and source MAC address MAC2 at edge Ethernet switch 42. Connection 71 goes through switches 11, 12, 13, 14, 15 in order, and reserves 5 Mbps bandwidth along the path.

It should be noted how the two frame streams originating from MAC1 and MAC2 get merged in switch 12, as determined by the filtering database instance shown in FIG. 5, so that the two streams share output port 123, but at switch 13 the streams are separated so that MAC2 is assigned, i.e., mapped, to output port 133 while MAC1 stream is assigned, i.e., mapped, to output port 134. By contrast, a loop free topology cannot allow stream merging and subsequent splitting due to the fact that in loop free topology, only the destination MAC address 710 determines the output port.

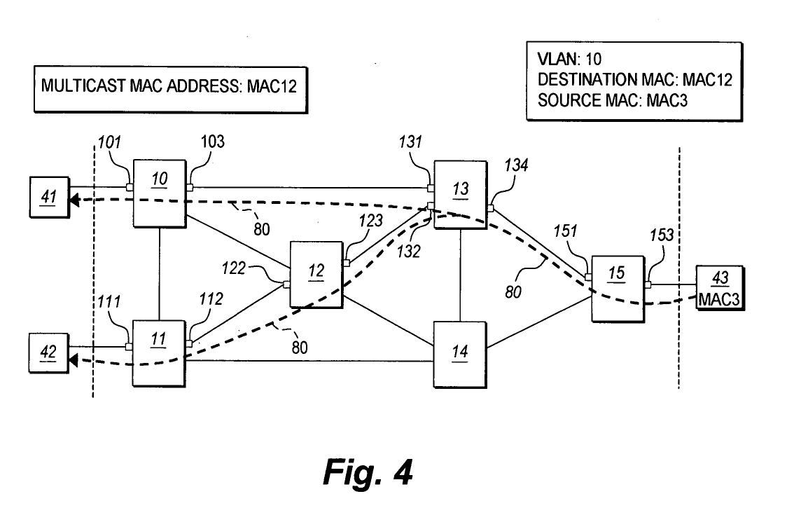

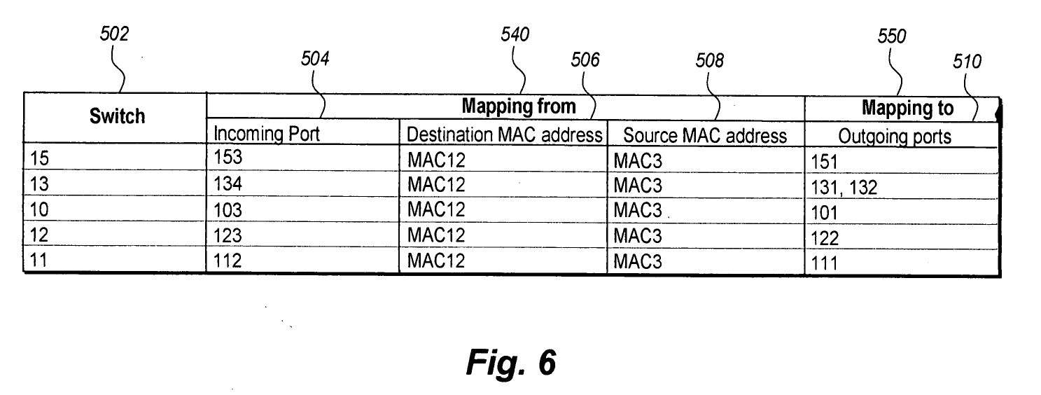

Moreover, because of the present invention's unique triple filter parameters shown in FIGS. 5 and 6, including the incoming port 504, the destination MAC address 710 as shown in table entry 506, and the source MAC address 720 as shown in table entry 508 utilized to map a frame 700 to an outgoing port 510 of a particular switch 502, traffic engineering, i.e., the flexibility of independently routing frame streams having the same destination MAC address 506 but different source MAC addresses 508 is extended into the domain of an individual virtual local area network, such as VLAN 10 as shown in FIGS. 3 and 4. In other words, the connection-based forwarding process of the present invention provides for merging and separating streams of frames 700 even though the frames 700 originate and terminate within the same VLAN 10. Frame 700 merging and separation facilitates improved traffic flow bandwidth because the forwarding path of an Ethernet traffic flow can be pre-determined in the network. As such, bandwidth resources can be allocated along the path for a particular traffic flow having a certain destination MAC address 710 and source MAC address 720.

FIG. 4 shows a uni-directional multicast connection 80 associated with VLAN 10. VLAN 10 associated connection 80 has multicast destination MAC address MAC12, and source MAC address MAC3 at edge Ethernet switch 43. This connection is provisioned by setting up connection-based forwarding databases as shown in FIG. 6. The multicast connection 80 goes to two receivers, switch 41 and switch 42. It splits at switch 13. As shown in the table entries depicted in FIG. 6, the forwarding database of switch 13 for VLAN 10 has a mapping that is applied to select two outgoing ports 131, and 132.

The connection-based forwarding process of the present invention is a method that can be embodied in a variety of systems having frame data traffic. The systems may be comprised of switches, bridges, and other network nodes, i.e., devices that transport layer 2 frame data. In addition to the Ethernet network embodiment described above, it is within the scope of the present invention to provide connection-based forwarding in other frame based networks such as, but not limited to Resilient Packet Ring (RPR) and the like. The method steps of the present invention herein described may be performed in specially adapted hardware such as programmable logic gate arrays, may be performed in computer software residing in, distributed among, or external to the network nodes of the present invention. Additionally, the method steps of the present invention herein described may be performed in a combination of hardware and the aforementioned software.

It is to be understood that the present invention is not limited to the embodiment described above, but encompasses any and all embodiments within the scope of the following claims.

I claim:

1. In an Ethernet network, a connection-based forwarding method comprising:
configuring in a plurality of network nodes, mappings for use in forwarding data frames, the mappings being from a plurality of triples comprising a plurality of incoming ports, a plurality of destination MAC addresses corresponding to a plurality of destination nodes of the network, and a plurality of source MAC addresses corresponding to a plurality of source nodes of the network, the mappings being to a plurality of selected output ports associated with the plurality of network nodes; and,
establishing at least one connection between at least one of the plurality of source nodes and at least one of the plurality of destination nodes of the network.

2. The connection-based forwarding method according to claim 1, further comprising: establishing a plurality of connections between the plurality of source nodes and the at least one of the plurality of destination nodes so that at least two of the plurality of connections are merged and separated at intermediate nodes en-route to the at least one of the plurality of destination nodes.

3. The connection-based forwarding method according to claim 2, wherein the plurality of connections between the plurality of source nodes and the at least one of the plurality of destination nodes further comprises a plurality of uni-directional unicast connections associated with a same VLAN.

4. The connection-based forwarding method according to claim 1, further comprising: establishing a uni-directional multicast connection between one of the plurality of source nodes and the plurality of destination nodes so that the uni-directional multicast connection is separated at least one intermediate node en-route to the plurality of destination nodes, wherein an address of the plurality of destination nodes is a multicast MAC address.

5. The connection-based forwarding method according to claim 1, wherein the configuring is performed manually.

6. The connection-based forwarding method according to claim 1, wherein the configuring is performed using network management software.

7. The connection-based forwarding method according to claim 1, further comprising: the configuring being instantiated based on a VLAN ID, wherein the connection-based forwarding method can use the same network physical resources that also have a connectionless based forwarding method running on them.

8. The connection-based forwarding method according to claim 1, wherein the configuring in a plurality of network nodes, mappings for use in forwarding data frames, further comprises setting up connection based forwarding tables functioning as filters in a database instance associated with a plurality of network switches.

9. The connection-based forwarding method according to claim 1, wherein bandwidth resources can be allocated along a path for a particular connection having a certain destination MAC address and source MAC address.

10. The connection-based forwarding method according to claim 8, wherein the setting up of the connection based forwarding tables further comprises creating the tables so that they each are dimensioned to have a plurality of rows by a plurality of columns, including a first column that accommodates at least one incoming port number for each row, a second column that accommodates a destination MAC address for each row, a third column that accommodates a source MAC address for each row, and a fourth column that accommodates at least one output port for each row.

11. In an Ethernet network, a connection-based forwarding system comprising: means for configuring in a plurality of network nodes, mappings for use in forwarding data frames, the mappings being from a plurality of triples comprising a plurality of incoming ports, a plurality of destination MAC addresses corresponding to a plurality of destination nodes of the network, and a plurality of source MAC addresses corresponding to a plurality of source nodes of the network, the mappings being to a plurality of selected output ports associated with the plurality of network nodes; and, means for establishing at least one connection between at least one of the plurality of source nodes and at least one of the plurality of destination nodes of the network.

12. The connection-based forwarding system according to claim 11, further comprising: means for establishing a plurality of connections between the plurality of source nodes and the at least one of the plurality of destination nodes so that at least two of the plurality of connections are merged and separated at intermediate nodes en- route to the at least one of the plurality of destination nodes.

13. The connection-based forwarding system according to claim 12, wherein the plurality of connections between the plurality of source nodes and the at least one of the plurality of destination nodes further comprises a plurality of uni-directional unicast connections associated with a same VLAN.

14. The connection-based forwarding system according to claim 11, further comprising: means for establishing a uni-directional multicast connection between one of the plurality of source nodes and the plurality of destination nodes so that the uni-directional multicast connection is separated at least one intermediate node en-route to the plurality of destination nodes, wherein an address of the plurality of destination nodes is a multicast MAC address.

15. The connection-based forwarding system according to claim 11, further comprising: means for instantiating the configuring, the means for instantiating being based on a VLAN ID, wherein the connection-based forwarding system comprises the same network physical resources also having a connectionless based forwarding system configured on them.

16. The connection-based forwarding system according to claim 11, further comprising: means for setting up connection based forwarding tables functioning as filters in a database instance associated with a plurality of network switches.

17. The connection-based forwarding system according to claim 11, further comprising: means for allocating bandwidth resources along a path for a particular connection having a certain destination MAC address and source MAC address.

18. The connection-based forwarding system according to claim 16, further comprising: means for creating the connection based forwarding tables so that they each are dimensioned to have a plurality of rows by a plurality of columns, including a first column that accommodates at least one incoming port number for each row, a second column that accommodates a destination MAC address for each row, a third column that accommodates a source MAC address for each row, and a fourth column that accommodates at least one output port for each row.

19. In an Ethernet network, a connection-based forwarding method performed by a machine executing a program of instructions tangibly embodied in a program storage device readable by the machine, the method comprising the steps of: configuring in a plurality of network nodes, mappings for use in forwarding data frames, the mappings being from a plurality of triples comprising a plurality of incoming ports, a plurality of destination MAC addresses corresponding to a plurality of destination nodes of the network, and a plurality of source MAC addresses corresponding to a plurality of source nodes of the network, the mappings being to a plurality of selected output ports associated with the plurality of network nodes; and, establishing at least one connection between at least one of the plurality of source nodes and at least one of the plurality of destination nodes of the network, wherein the at least one connection can alternatively be split, merged with another connection, and separated from another connection at intermediate nodes en-route to the at least one of the plurality of destination nodes.

20. In a frame-based network, a connection-based forwarding method comprising: establishing a first and second connections having a same destination MAC address, a same VLAN ID, and passing through a common switching node of the network; and, configuring the switching node to forward data frames of the connections differently based on a triple, the triple comprising an incoming port, a destination MAC address, and a source MAC address, wherein data traffic engineering is enabled.
